(19) United States
(12) Patent Application Publication
(10) Pub. No.: US 2007/0024454 A1
(43) Pub. Date: Feb. 1, 2007

(54) System and method for mental impairment determination using reaction time test

(76) Inventor: Tara Chand Singhal, Torrance, CA (US)

Correspondence Address: Tara Chand Singhal, P.O. Box 5075, Torrance, CA, 90510, US

(21) Appl. No.: 11/497,047

(22) Filed: Aug. 1, 2006

Related U.S. Application Data
(60) Provisional application No. 60/704,585, filed on Aug. 1, 2005.

(51) Int. Cl. G08B 23/00

(52) U.S. Cl. 340/576; 180/287; 307/10.1; 340/5.52

(57) ABSTRACT

This invention discloses a satellite based Driver Mentally Impaired (DMI) determination system for auto safety that automatically enables, (i) at the time of auto ignition by driver, the vehicle to be identified at ground station in a Driver mentally impaired (DMI) database and to activate the functions of DMI safety function, (ii) the driver to be identified via voice sample, (iii) the driver profile to be identified in the DMI database, including the time slots when the driver might be drunk, such as evening time and not morning time, (iv) a reaction time test to be conducted, which measures the reaction time responses to simple questions, (v) determine the driver's ability to drive, based on driver specific and generic reaction time profiles and (vi) permit the ignition to proceed or not, (vii) If the ignition is denied, it can be done again after a fixed time and/or a designated person and telephone number is automatically dialed and the safety situation to include driver name, vehicle location, time and degree of impairment is conveyed to.

### CROSS REFERENCE TO RELATED APPLICATIONS

This application claims priority on Provisional Application Ser. No. U.S. 60/704,585, titled “AUTO SAFETY FUNCTION FOR MENTALLY IMPAIRED DRIVERS USING A SATELLITE BASED SYSTEM AND REACTION TIME TEST” filed on Aug. 1, 2005, by Tara Chand Singhal and Devendra Singhal. The contents of the Provisional Application Ser. No. 60/704,585 are incorporated herein by reference.

### FIELD OF THE INVENTION

The present invention is directed to a method and apparatus for preventing mentally impaired drivers from driving vehicles by using reaction time tests administered at the time of auto ignition.

### BACKGROUND

Drinking and driving is a serious social issue with severe repercussions in many areas. Alcohol-related motor vehicle crashes kill someone every 31 minutes and non fatally injure someone every two minutes (NHTSA 2004a). The following information researched from the Internet, provides an overview of the scope of the problem, the repercussions to the society and what has been done to address this problem.
During 2003, 17,013 people in the U.S. died in alcohol-related motor vehicle crashes, representing 40% of all traffic-related deaths (NHTSA 2004a).
In 2002, about 1.5 million drivers were arrested for driving under the influence of alcohol or narcotics (NHTSA 2004a). That's slightly more than one percent of the 120 million self-reported episodes of alcohol-impaired driving among U.S. adults each year (Dellinger 1999).
Drugs other than alcohol (e.g., marijuana and cocaine) are involved in about 18% of motor vehicle driver deaths. These other drugs are generally used in combination with alcohol (NHTSA 2003).
More than two-thirds of child passengers ages 14 and younger who died in alcohol-related crashes during 1997-2002 were riding with the drinking driver; only 32% of them were properly restrained at the time of the crash (Shults 2004).
   Each year, alcohol-related crashes in the United States cost about $51 billion (Blincoe 2002).
Male drivers involved in fatal motor vehicle crashes are almost twice as likely as female drivers to be intoxicated with a blood alcohol concentration (BAC) of 0.08% or greater (NHTSA 2004b). A BAC of 0.08% is equal to or greater than the legal limit in most states.
At all levels of blood alcohol concentration, the risk of being involved in a crash is greater for young people than for older people (Zador 2000). In 2003, 25% of drivers ages 15 to 20 who died in motor vehicle crashes had been drinking alcohol (NHTSA 2004c).
Young men ages 18 to 20 (under the legal drinking age) reported driving while impaired almost as frequently as men ages 21 to 34 (Liu 1997).
Nearly three quarters of those convicted of driving while impaired are either frequent heavy drinkers (alcohol abusers) or alcoholics (alcohol dependent) (Miller 1986).
Among drivers involved in fatal crashes, those with BAC levels of 0.08% or higher were nine times more likely to have a prior conviction for driving while impaired (DWI) than were drivers who had not consumed alcohol (NHTSA 2004a).
Actions to decrease alcohol-related fatal crashes involving young drivers have been effective. Over the past 20 years, alcohol-related fatal crash rates have decreased by 60 percent for drivers ages 16 to 17 years and 55 percent for drivers ages 18 to 20 years. However, this progress has stalled in the past few years. To further decrease alcohol-related fatal crashes among young drivers, communities need to implement and enforce strategies that are known to be effective, such as minimum legal drinking age laws and “zero tolerance” laws for drivers under 21 years of age.
Sobriety checkpoints reduce alcohol-related crashes. Fewer alcohol-related crashes occur when sobriety checkpoints are implemented, according to a CDC report published in the December 2002 issue of Traffic Injury Prevention. Sobriety checkpoints are traffic stops where law enforcement officers systematically select drivers to assess their level of alcohol impairment. The goal of these interventions is to deter alcohol-impaired driving by increasing drivers' perceived risk of arrest. The conclusion that they are effective in reducing alcohol-related crashes is based on a systematic review of research about sobriety checkpoints. The review was conducted by a team of experts led by CDC scientists, under the oversight of the Task Force on Community Preventive Services—a 15-member, non-federal group of leaders in various health-related fields. (Visit www.thecommunityguide.org for more information.) The review combined the results of 23 scientifically sound studies from around the world. Results indicated that sobriety checkpoints consistently reduced alcohol-related crashes, typically by about 20 percent. The results were similar regardless of how the checkpoints were conducted, for short-term “blitzes,” or when checkpoints were used continuously for several years. This suggests that the effectiveness of checkpoints does not diminish over time.
Stronger state DUI prevention activities may reduce alcohol-impaired driving. Strong state activities designed to prevent driving under the influence (DUI), including legislation, enforcement, and education, may reduce the incidence of drinking and driving, according to a study from the Centers for Disease Control and Prevention (CDC). For the study, which was published in the June 2002 issue of Injury Prevention, CDC analyzed data from the 1997 Behavioral Risk Factor Surveillance System (BRFSS) national telephone survey, and the Mothers Against Drunk Driving (MADD) Rating the States 2000 survey, that graded states on their DUI countermeasures from 1996-1999. Results showed that residents of states with a MADD grade of “D” were 60 percent more likely to report alcohol-impaired driving than were residents from states with a MADD grade of “A.” MADD based the grades on 11 categories of prevention measures, including DUI legislation; political leadership; statistics and records availability; resources devoted to enforcing DUI laws; administrative penalties and criminal sanctions; regulatory control and alcohol availability; youth DUI legislation; prevention and education; and victim compensation and support.
The study also found that 4 percent of the residents who consume alcohol reported they had driven after having too much to drink at least once during the previous month. Men were nearly three times as likely as women to report alcohol-impaired driving, and single people were about 50 percent more likely to report alcohol-impaired driving than married people or those living with a partner.
CDC's findings about the number of children killed in cars driven by drinking drivers has led legislators in several states to introduce bills to help protect them from drinking drivers. Such legislation creates special penalties under state child abuse laws for persons who transport children while driving drunk. Results from the study showed that nearly two-thirds of children killed in drinking driver-related crashes were riding with the impaired driver. Fewer than 20 percent of the children killed were properly restrained at the time of the crash, and restraint use decreased as the driver's blood alcohol concentration increased.
   Effective measures to prevent injuries and deaths from impaired driving include:
Promptly suspending the driver's licenses of people who drive while intoxicated (DeJong 1998).
Lowering the permissible levels of blood alcohol concentration (BAC) for adults to 0.08% in all states (Shults 2001).
Zero tolerance laws for drivers younger than 21 years old in all states (Shults 2001).
Sobriety checkpoints (Shults 2001).
Multi-faceted community-based approaches to alcohol control and DUI prevention (Holder 2000, DeJong 1998).
Mandatory substance abuse assessment and treatment for driving-under-the-influence offenders (Wells-Parker, 1995).
   Other suggested measures include:
Reducing the legal limit for blood alcohol concentration (BAC) to 0.05% (Howat 1991; National Committee on Injury Prevention and Control 1989).
Raising state and federal alcohol excise taxes (National Committee on Injury Prevention and Control 1989).
Implementing compulsory blood alcohol testing when traffic crashes result in injury (National Committee on Injury Prevention and Control 1989).

When alcohol is consumed, it passes from the stomach and intestines into the blood, a process referred to as absorption. Alcohol is then metabolized by enzymes, which are body chemicals that break down other chemicals. Most of the alcohol consumed is metabolized in the liver, but the small quantity that remains unmetabolized permits alcohol concentration to be measured in breath and urine.

The liver can metabolize only a certain amount of alcohol per hour, regardless of the amount that has been consumed. The rate of alcohol metabolism depends, in part, on the amount of metabolizing enzymes in the liver, which varies among individuals and appears to have genetic determinants (1,4). In general, after the consumption of one standard drink, the amount of alcohol in the drinker's blood (blood alcohol concentration, or BAC) peaks within 30 to 45. Alcohol is metabolized more slowly than it is absorbed. Since the metabolism of alcohol is slow, consumption needs to be controlled to prevent accumulation in the body and intoxication.

A number of factors influence the absorption process, including the presence of food and the type of food in the gastrointestinal tract when alcohol is consumed (2,6). The rate at which alcohol is absorbed depends on how quickly the stomach empties its contents into the intestine. The higher the dietary fat content, the more time this emptying will require and the longer the process of absorption will take. One study found that subjects who drank alcohol after a meal that included fat, protein, and carbohydrates absorbed the alcohol about three times more slowly than when they consumed alcohol on an empty stomach (7).

Women absorb and metabolize alcohol differently from men. They have higher BAC's after consuming the same amount of alcohol as men and are more susceptible to alcoholic liver disease, heart muscle damage (8), and brain damage (9). The difference in BAC's between women and men has been attributed to women's smaller amount of body water, likened to dropping the same amount of alcohol into a smaller pail of water (10). An additional factor contributing to the difference in BAC's may be that women have lower activity of the alcohol metabolizing enzyme ADH in the stomach, causing a larger proportion of the ingested alcohol to reach the blood.

Prior efforts to address the DUI have also included creating a portable blood alcohol content test device in the vehicle itself that is integrated with the ignition control of the vehicle. For example, a miniature device that is part of a key fob was being developed by SAAB, an auto company where there is a small tube for the driver to blow into and if the BAC is over the safe limit, a red light instead of a green light on the key fob is indicated and then the key would not work to start the automobile for a certain period of time.

In light of the above, better or other systems and methods are needed to address the serious issues of DUI. Hence it is an objective of the present invention to have an apparatus and methods for a system that prevents mentally impaired drivers to be able to drive a vehicle that does not have the limitations of the prior art as described here.

### SUMMARY

Based on the work of Gail Gleason Milgram, Ed.D, Research, Professor and Director of the Education and Training Division at the Rutgers University Center of Alcohol Studies:

“Alcohol acts directly on the brain, and affects its ability to work. The effects of alcohol on the brain are quite complex, but alcohol is usually classified as a depressant. Judgment is the first function of the brain to be affected; the ability to think and make decisions becomes impaired. As more alcohol is consumed, the motor functions of the body are affected.

The effects of alcohol are directly related to the concentration (percentage) of alcohol in the blood; however, the effects vary among individuals and even in the same individual at different times. In the following description, the blood alcohol concentrations (BAC) are those that would probably be found in a person weighing about 150 pounds:

At a BAC of 0.03% (after about one cocktail, one glass of wine, or one bottle of beer), the drinker will feel relaxed and experience a slight feeling of exhilaration.

At 0.06% (after two cocktails, two glasses of wine, or two bottles of beer), the drinker will experience a feeling of warmth and relaxation; there will be a decrease of fine motor skills and he or she will be less concerned with minor irritations.

At 0.09% (after three cocktails, three glasses of wine, or three bottles of beer), reaction time will be slowed, muscle control will be poor, speech will be slurred and the legs will feel wobbly.

At 0.12% (after four cocktails, four glasses of wine, or four bottles of beer), his or her judgment will be clouded, inhibitions and self-restraint lessened, and the ability to reason and make logical decisions will be impaired.

At 0.15% (after five cocktails, five glasses of wine, or five bottles of beer), vision will be blurred, speech unclear, walking will be unsteady, and coordination impaired. At 0.18% (after six cocktails, six glasses of wine, or six bottles of beer), all of the drinker's behavior will be impaired, and he or she will find it difficult to stay awake.

At a BAC of about 0.30% alcohol in the blood (after 10 to 12 drinks), the drinker will be in a semi-stupor or deep sleep. Most people are not able to stay awake to reach a BAC higher than 0.30%.

If the BAC reaches 0.50% the drinker is in a deep coma and in danger of death. As the alcohol level reaches 1% in the blood, the breathing center in the brain becomes paralyzed and death occurs.

In many states a BAC of 0.10% is considered legal evidence that a driver is intoxicated; some states use a BAC of 0.08%. In some European countries the legal BAC is as low as 0.05%.”

The Gleason-Milgram work, as described above, makes a direct link between BAC and the reaction time. For example, the study specifically states that “at 0.09% BAC (after three cocktails, three glasses of wine, or three bottles of beer), reaction time will be slowed, muscle control will be poor, speech will be slurred and the legs will feel wobbly.”

The Gleason-Milgram work also makes a determination that the reaction time becomes impaired first before the motor functions are impaired. The study states “Judgment is the first function of the brain to be affected; the ability to think and make decisions becomes impaired. As more alcohol is consumed, the motor functions of the body are affected.”

It is believed, that the changes in reaction time would be evident earlier and become clearly evident to a casual observer at or around 0.09 BAC. If there was a means of measuring the change in reaction time from that at being sober to that approaching drunkenness, changes in reaction time would be evident earlier than at BAC of 0.09.

Given the disparity of how alcohol acts on the body over time and how its affects the brain leading to changes in reaction time and motor functions for individual people based on their weight, gender, and tolerance to alcohol, this invention discloses a way to measure mental impairment of a driver by measuring reaction time at the time of attempted auto ignition and use the reaction time results to stop a driver from starting the vehicle.

In the preferred embodiment, this invention uses a prior art satellite based auto safety system similar to what is marketed in US by GM under the brand name On Star, Such a prior art auto safety system is adapted (i) to perform a Driver Mental Impairment (DMI) safety function reaction time tests using the interactive voice response features that would measure the reaction time of the driver and (ii) controls the ability to start the car based on the outcome of such reaction time tests.

This invention automatically enables, (i) at the time of auto ignition by driver, the vehicle to be identified at ground station in the DMI database and to activate the functions of DMI safety function, (ii) the driver to be identified via voice sample, (iii) the driver profile to be identified in the DMI database, including the time slots when the driver might be drunk, such as evening time and not morning time, (iv) a reaction time test to be conducted, which measures the reaction time responses to simple questions, (v) determine the driver's ability to drive, based on driver specific and generic reaction time profiles and (vi) permit the ignition to proceed or not, (vii) If the ignition is denied, it can be done again after a fixed time and/or a designated person and telephone number is automatically dialed and the safety situation to include driver name, vehicle location, time and degree of impairment is conveyed to.

The reaction time tests of this invention take a very short time by asking a few simple questions, at the time of ignition and personalize the execution of such tests to the drinking profile of individual drivers. This invention, it is believed would be convenient to use for a large group of users as described below.

This large group of users includes those who have a drinking problem as drinking and driving are repeat offenses. Nearly three quarters of those convicted of driving while impaired are either frequent heavy drinkers (alcohol abusers) or alcoholics (alcohol dependent) (Miller 1986). Among drivers involved in fatal crashes, those with BAC levels of 0.08% or higher were nine times more likely to have a prior conviction for driving while impaired (DWI) than were drivers who had not consumed alcohol (NHTSA 2004a). In this class of drivers their vehicles may be equipped with the apparatus and methods of this invention by a court or legal order.

Another large group of users includes those who may tend to drink socially or drink excessively over the holidays and weekends. For this class of drivers, their vehicle may be equipped with this invention by community and family inducement and pressure as a safety mechanism that becomes active only when needed. Centralized implementation of this invention by a software-based system, enables the driver safety profile to be updated from an Internet based interface by an authorized person.

Centralized implementation of this invention by a software-based system also enables the cost to users to be spread among large group of users nationwide. However, in an alternative embodiment, where a satellite based system may not be a option, this invention using reaction time tests at the time of ignition may be also be implemented in a computing device placed in the car without the need to interface with the satellite based system.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts. The drawings are:

FIGS. 1A-B are block diagrams that illustrate a DMI safety system version of the current invention.

FIGS. 2A-2D are diagrams that illustrate use of reaction time tests of the current invention of a DMI safety function.

FIG. 3 is a block diagram that illustrates the Set up functions of the DMI safety function system of the current invention.

FIG. 4 is illustration of DMI database of this invention.

FIG. 5 is a flow diagram that illustrates a version of the operation of the DMI system of the current invention.

### DESCRIPTION

### Introduction

This invention discloses a temporary mental impairment determination system that has a device that generates an aural stimulus in the form of a question to be heard by a subject and that requires a response from the subject. The device has means to receive aural response to the stimulus from the subject and a measurement means to measure the aural response to determine degree of mental impairment of the subject, for the ability to safely operate machinery.

The measurement means may include a plurality from the group of, the timeliness of the response relative to the stimulus and accuracy of the response relative to the stimulus. These measurements are termed as reaction time tests and measure the reaction time of the subject that correlates with the degree of mental impairment to be able to judge and make decisions that would be indicative of the ability to safely operate machinery such as an auto vehicle or industrial machinery.

The stimulus is in the form of a simple question that requires a verbal response or a motor response that can be detected and measured. The simple question may be what is your name or what is 2 plus 4, or blow the horn two times. The response is a speech or sound that can be picked up by a microphone and with the help of prior art speech recognition and processing technology be able to measure the response for timeliness and or accuracy. Prior art speech processing technologies and devices provide the ability to be able to receive process and precisely measure speech and sound responses.

An embodiment of this invention is an apparatus that may be held-hand by law enforcement official and may be used to determine sobriety of a mentally impaired driver. Another embodiment is that the apparatus may be attached to machinery and may be used to determine degree of mental impairment to be able to safely operate industrial machinery by an operator.

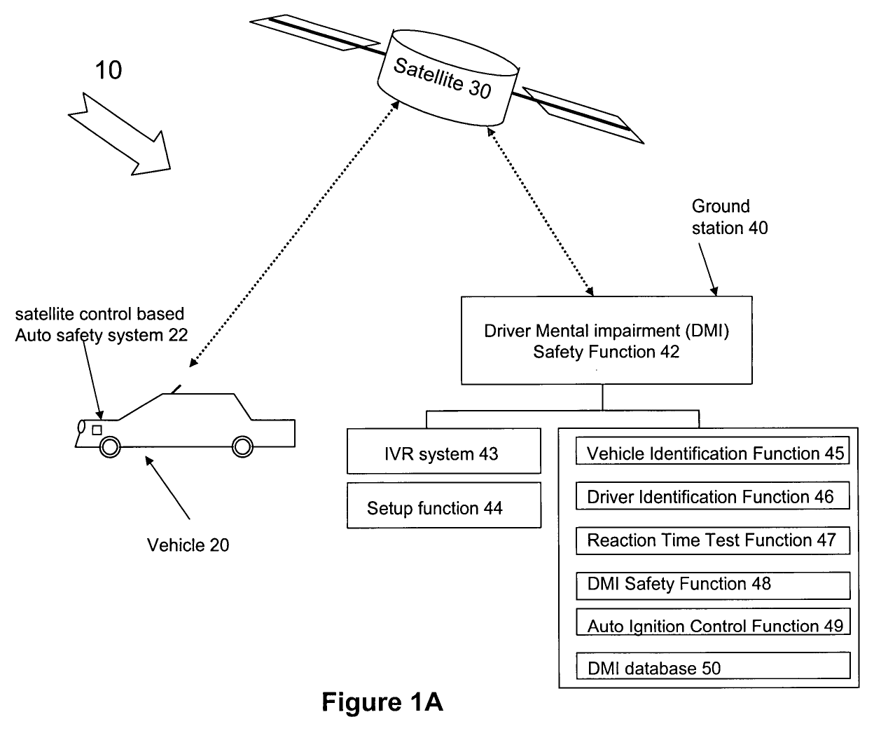

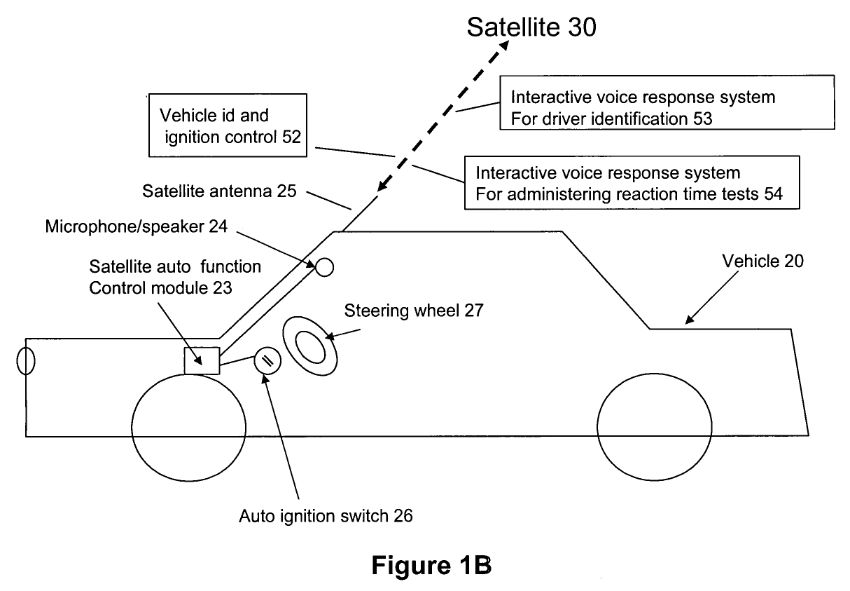

The embodiment related to a Driver Mentally Impaired (DMI) Safety Function System 10 that is part of the auto-ignition system is described in detail here. In one version of this embodiment, a Driver Mentally Impaired (DMI) Safety Function System 10 that uses certain features of a prior art satellite based auto safety system is described here with reference to FIGS. 1A and 1B.

With reference to FIG. 1A, the system 10 has a prior art satellite control based auto safety system 22 in a vehicle 20, a satellite 30, and a ground station 40, where the ground station 40 is capable to control vehicle functions and can interact with the driver via verbal interface with an operator in the ground station 40. An example of such a system is On Star that is marketed by General Motors Corporation in the US. For example, when the air bags are activated, the system automatically connects to an operator in the ground station and the operator is able to determine the location of the vehicle using GPS and the operator can communicate with the driver. Also, when the driver pushes a button, the driver can verbally communicate with an operator in the ground station for any number of services to do with the vehicle and not do with the vehicle. For example the operator can control functions of the car such as lock/unlock doors and disable ignition.

This invention provides for a centralized Driver Mental Impairment (DMI) Safety Function 42 in the ground station 40 that uses certain features of the prior art satellite based auto safety system. The function 42 includes an Interactive Voice Response (IVR) system 43, a set up function 44, a vehicle identification function 45, a driver identification function 46, a reaction time test function 47, a DMI safety function 48, an auto ignition control function 49, and a DMI database 50.

With reference to FIG. 1B, the vehicle 20 has a satellite auto function control module 23, auto ignition switch 26, microphone/speaker 24, steering wheel 27, and a satellite antenna 25. These enable, (i) vehicle id and ignition control commands 52, (ii) driver identification via voice sample 53, and (iii) reaction time test commands and responses 54 to travel from the vehicle 20 to the ground station 40 via satellite 30.

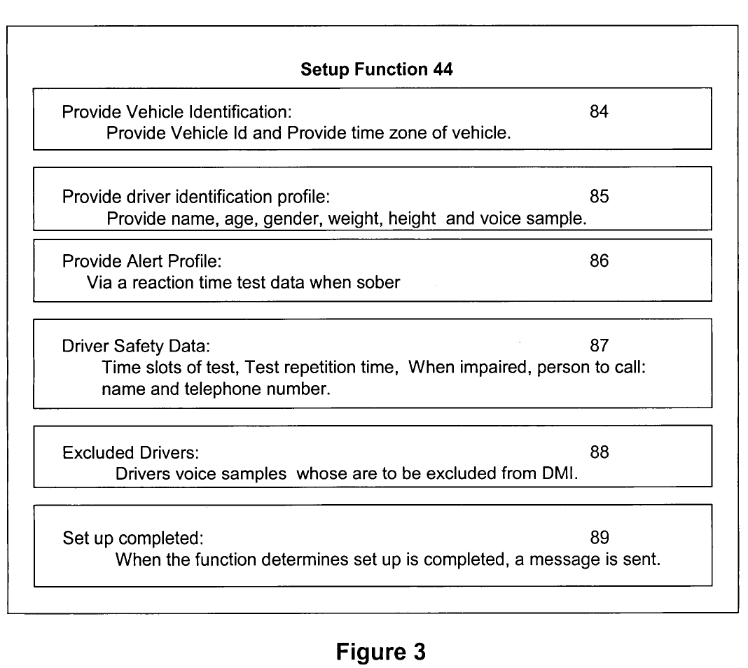

With reference to FIG. 1A, the system 10 also provides a setup function 44 that enables the DMI safety function 42 to be activated by setting up the driver and vehicle profile, as described later with reference to FIG. 3. These and other functions are described herein, where the headings are provided for the convenience of the reader.

Interactive Voice Response (IVR) System 43

IVR systems are commonly used in prior art, in applications, such as, banking, where a person via telephone can interact with a banking system to conduct a financial transaction. IVR are also used in many other business applications.

An IVR system has two parts. One part is called “grammar” and enables spoken words to be recognized. The second part is called text-to-speech processor and enables English text to be spoken to the person. An IVR computer system can execute a voice xml script that carries out IVR functions. An IVR can interface with a database application and can search, enter or retrieve data elements from a database application that can be used for interacting with a caller to an IVR system. An IVR system via the use of VXML language may be programmed in any number of ways for any number of applications.

Grammar part enables the spoken words to be automatically recognized and compared against a list of predefined spoken words irrespective of the accent of the user. For example, words, and numbers are built into the grammar library that would be recognized. If the spoken response is unclear, the prompt may be repeated. Also the time window for a voice response to a question may be programmed. The IVR systems of today are very sophisticated in what they can do and new capabilities are being added continuously. One example is that a “bargein=True/False” feature enables when the time window for processing the voice response becomes active.

This invention uses IVR to deliver questions that measure reaction time by measuring the timeliness and the accuracy of the responses. In particular, the time interval from the time a question is spoken and the time when the response begins or is completed is measured in seconds or fractions of seconds. The ability of the IVR systems to measure time to response for a prompt is considered prior art and hence not described here. The IVR systems, their features and capabilities, are considered prior art and are not described in here.

In addition to IVR, there are prior art speech-processing applications that enable identification of a person by voice samples. This invention uses capturing a voice sample of driver name and uses speech processing to identity a driver when he/she speaks his/her name from a group of drivers assigned to a car so that the safety functions of this invention become activated for one or more drivers and not all drivers. The speech processing for “voice identification” that is to be able to identity a person by voice sample is considered prior art and is not described here.

Setup Function 44

With reference to FIG. 1A, the Setup function enables the setup of the DMI safety function 42 for individual auto and individual drivers by providing data to DMI database 50. The set up function may be initiated from inside the vehicle using prior art Satellite system 22 and IVR system 43. Alternatively, the set up function may be initiated over the Internet.

The following data items in the DMI database 50 may need to be set up, as shown in FIG. 3.

Vehicle Identification 84

Vehicle identification is provided to the Setup function by speaking the Vehicle Identification number to the IVR on system prompt. Also speaking the time zone to the IVR provides the time zone where the vehicle is driven.

Driver Identification 85

Driver identification includes (i) name, (ii) age, weight (iii), gender, and voice sample.

These can be entered via IVR or via Internet. The age and gender factors enable these factors to be used in generating a generic reaction time profile for similarly situated drivers based on age and gender. Other individual characteristic such as weight and height may also be used.

Driver Alert Profile 86

The driver reaction times may be measured when sober using a series of simple questions and the time for their response is recorded via the IVR. If the driver does not perform such driver specific reaction time test at sober, then a generic reaction time based on his gender and weight may be used.

Driver Safety Data 87

Safety-data is collected on three different aspects. These aspects are:

Drinking Profile. In the drinking profile, the daily, weekly and yearly profile of the drinking habits of the driver are collected, by entering the times of day, the driver may indulge in drinking such as from 8.00 PM to 4.00 AM time window, days such as Weekend and not weekdays, and specific holiday periods.

Test Repetition: When a driver is judged mentally impaired by the DMI safety function, test repetition determines when to enable repetition of the reaction time test. This item may be set in increments of 30 minutes such as 1 hour or 2 hours or 2.30 hours. This feature of the invention enables a driver to metabolize his alcohol over time and become sober again to be able to pass the reaction tests to be able to drive.

Dial Out: Name and telephone number of the person to call, along with make, model and license number of the vehicle being driven by the driver is entered in the DMI database. The dial out information may be used when the driver is impaired and based on the severity of impairment.

Driver Exclusion 88: The names of drivers, such as family members for whom the DMI test is not desired or applicable, their names are spoken into the IVR to be added into the DMI database so that they may be easily excluded from the reaction time tests.

Set Up Completed 89: At the completion of the Set up function, a message is delivered that profile for this driver has been completed. Similarly, profiles of other drivers may be added.

DMI Safety Function 42

With reference to FIG. 1A, the following functions are used as part of DMI safety function test, when an auto ignition is attempted for a vehicle for which DMI safety function 42 has been set up as described above.

Vehicle Identification Function 45

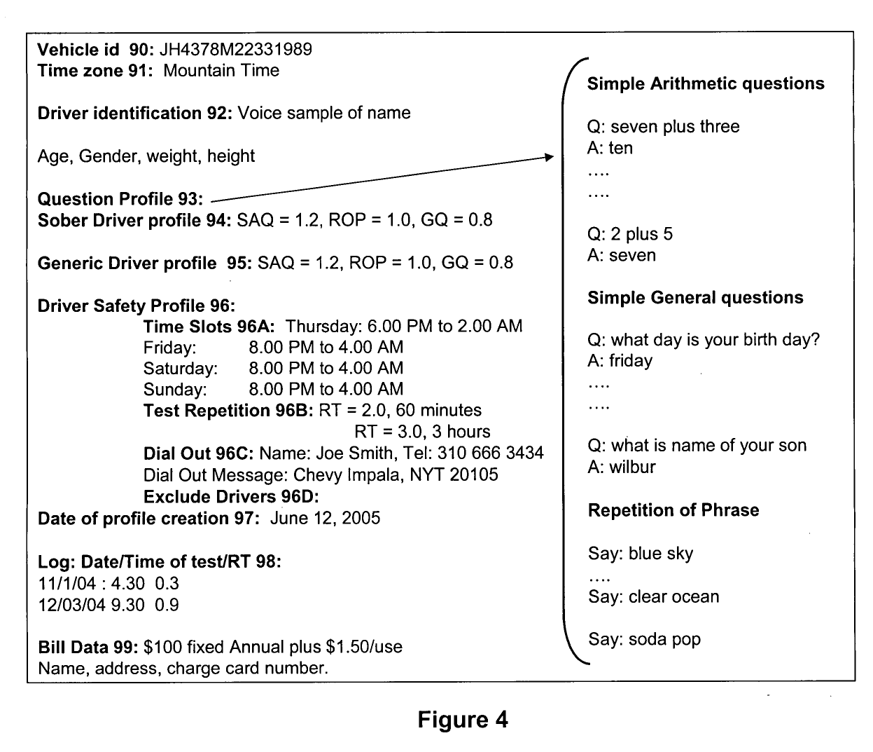

This function 45, receives the Vehicle Id sent from vehicle 20 via the prior art Satellite system 22, and looks up vehicle id 90 in the DMI database 50, as show in FIG. 4, to extract the driver profile and other data. If the vehicle id is not present in the database, no action is taken and the function is exited.

Driver Identification Function 46

This function identifies the driver by voice sample received via IVR from the vehicle, when IVR prompts for name and compares the voice sample with what is present in the DMI database 50 by voice sample comparison and retrieves the driver profile.

If the driver is drunk when starting the car, then the question “say your name” as part of driver identification would not be responded to by the drunk driver in the appropriate time and the question then becomes part of the reaction time test function as described below.

Reaction Time Test Function 47

Since the first function of the brain to be affected is reaction time before motor functions, it is believed, that a reaction time test of the driver can be used as reliable indicator to determine impairment of driver due to blood alcohol.

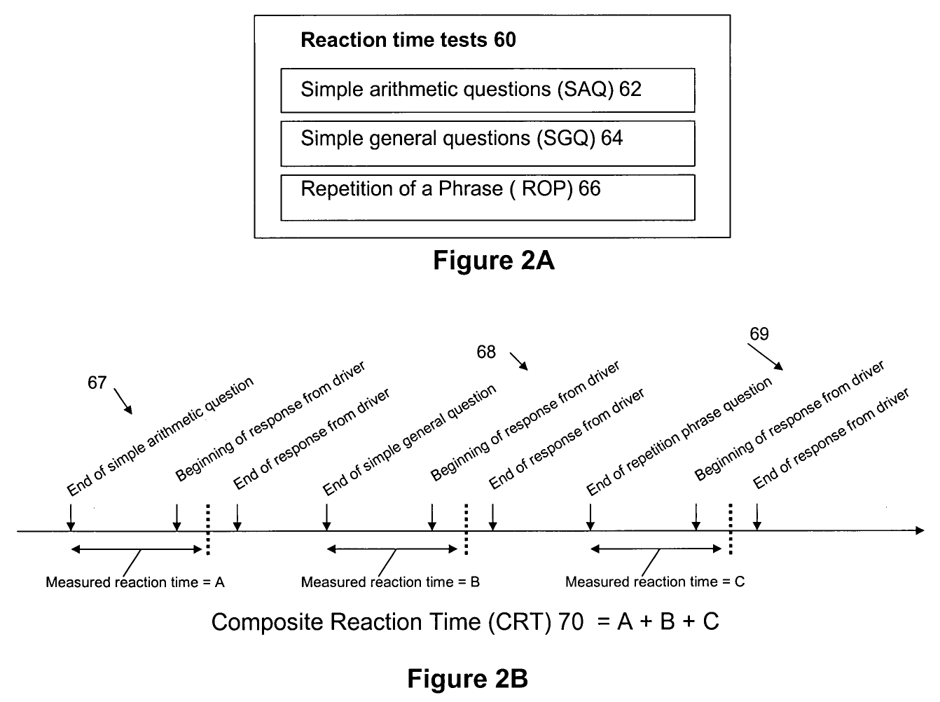

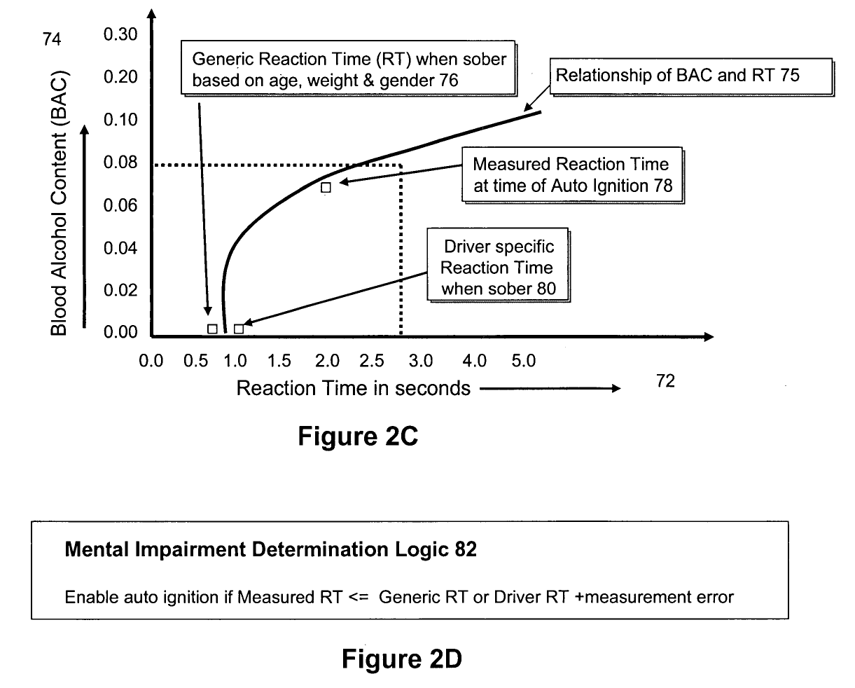

As shown in FIG. 2A, such reaction time tests can be based on different types of simple questions. There may be simple arithmetic questions 62, simple general question 64, and simple repetition of phrase 66. The accuracy and promptness of the answers would measure the reaction time and hence the degree of impairment when compared to reaction time when sober. Such reaction times tests involving speaking a question and awaiting a response to the question can be remotely and easily conducted by an IVR system.

For a reaction time test, the type of questions SAQ 62, SGQ 64 and ROP 66 may be any number and may be mixed in any order. However, one of each is preferred as it would be indicative of drunk driver or not and can be done fairly quickly in about thirty seconds. If the reaction time results are ambiguous by using three such questions, more questions may be added. Depending upon the response less or more questions may be asked. It is desired to keep the test to be less than thirty seconds long.

For example, the SAQ may be “what is three plus five”, the SGQ may be “what is your dog's name, and ROP may be, “say black horse”. These questions can be randomly selected from a database of question such that a different question set is presented each time a reaction time is test is carried out. Furthermore, a set of questions such as three, five, or more may be use and an average reaction time computed from their responses.

Furthermore, other tests may be used such as a command to blow horn two times now and comparing the time when the horns sounds may be used as an indicator of impairment of motor functions.

Such questions require ability to hear and comprehend, think and then respond. If the brain function is affected, this will show up in the reaction time tests. The test may be discontinued, if after as few as three questions there is no response or a long reaction time response is provided. If no response is heard by the IVR in response to a question, a time out is declared. A time out may be declared after five seconds.

As shown in FIG. 2B, the time when the simple arithmetic question 67 ends and the time when the response begins and ends of the driver may be used to measure the reaction time A of the driver. The time when the simple general question 68 ends and the time when the response begins and ends of the driver may be used to measure the reaction time B. The time when the repetition of a phrase 69 prompt ends and the time when the response begins and ends of the driver may be used to measure the reaction time C of the driver. A composite reaction time (CRT) 70 may be computed by adding the individual responses of these three reaction time measurements A, B and C.

FIG. 2C shows the relationship of blood alcohol content (BAC) and reaction time (RT). Reaction time is plotted on the X-axis 72 and BAC is plotted on the Y-axis 74. A relationship of BAC and RT is shown via graph 75, where the sober reaction time may start in the vicinity of one second and stay there for low blood alcohol contents such as 0.02 to 0.04, and then the reaction time increase rapidly for higher BAC values. For example, at BAC of 0.06, the reaction time may be double of what it was at being sober. Such a graph is a function of driver weight and other factors. As an illustration, the graph show generic reaction time based on age and weight 76, the driver specific reaction time 80 and the measured reaction time 78.

As shown in FIG. 2D, these values may be used to determine if the driver is mentally impaired to be able to drive a vehicle. The mental impairment determination logic 82 may be:

Enable auto ignition if Measured RT 78 is less than or equal to (either the generic reaction time 76 or the driver specific reaction time 80) plus a measurement error. If the driver specific reaction time was provided at the time of set up function, then this is used. If it was not provide, then the generic reaction time is used.

For example, if the Measured Reaction Time is 1.5 second, the sober reaction time is 1 second, and the measurement error is 0.5 second, then since 1.5 is less than or equal to 1.0 plus 0.5 seconds, the logic 82 would enable the auto ignition to proceed. However, if the measured reaction time was 2.0 second, then since 2.0 is not less than or equal to 1.0 plus 0.5 second, the auto ignition would be denied. The logic 82, as described here is merely illustrative and different or other logic may also be used.

DMI Safety Function 48

As shown in FIG. 1A, this function uses the DMI database 50 entries to enable the reaction time tests to be activated based upon the driver specific profile based on his/her drinking habits. For example, the test is only conducted in the evening or weekends and not in the morning, if the profile so indicates.

This function also enables reaction time test repetition after a set time when driver is determined to be mentally impaired. The time may be computed for this specific driver based on degree of failure of first test. For example, when the alcohol is metabolized the driver may be sober enough to drive again. This function would enable the reaction time test to be conducted again for this driver after one hour.

This function also enables, alternatively or in addition, when impaired, dial out call to a person on a specified telephone number, and a message is delivered by the IVR. For example, the message may be “driver name in vehicle Chevrolet impala, Number 2YUT 334, at location local bar, at this time 11.30 PM on date Jul. 12, 2005, is mentally impaired and unable to drive.”

Auto Ignition Control Function 49

This function sends ignition close loop command to the vehicle when it is determined by the functions described above that is permissible to complete attempted auto ignition.

DMI Safety Function Database 50

As shown in FIG. 1A, the DMI database 50 facilitates the operation of the DMI safety function 42 and keeps data for the vehicle, the driver profile and generic safety profile.

As shown in FIG. 4, the DMI database has fields for Vehicle id 90, time zone 91, driver identification 92, reaction time question profile 93, sober driver profile 94, generic driver profile 95, driver safety profile 96. The driver safety profile includes fields for time slots 96A, test repetition 96B, dial out data 96C, and exclude driver's 96D. The DMI database 50 also has fields for date of profile creation 97, log of data 98 to include date, time and RT, and bill data 99 enabling a fee to be charged for the use of the system.

The RT question profile 93, as shown may include a set of questions from which, at random, a number of questions may be used to conduct a reaction time test. The time slots 96A, as shown, may include the times and days, when the safety function should be invoked. The exclude-drivers 96D may include voice samples of drivers for whom the safety function is not applicable

Operation

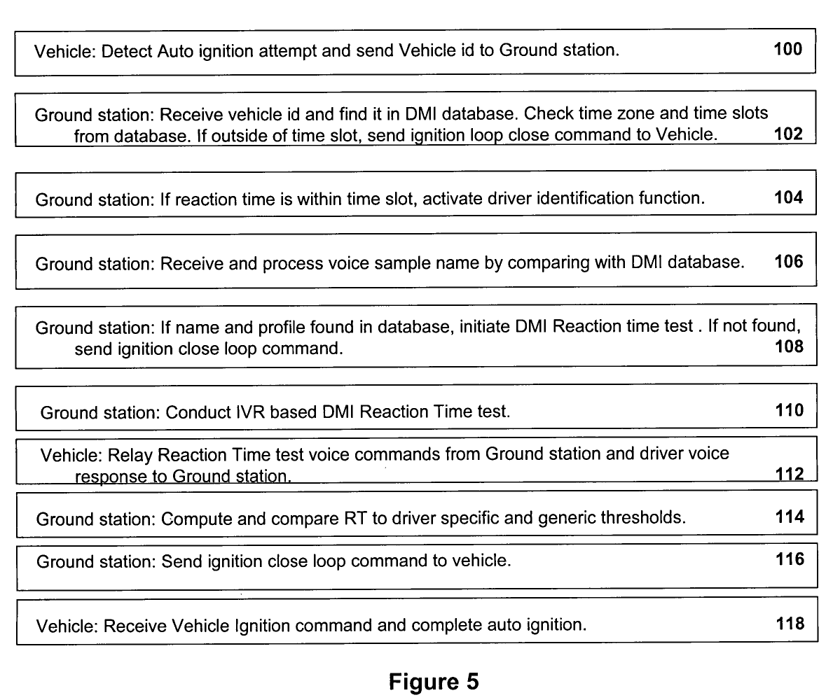

The operation of the invention can be understood with reference to FIG. 5. Not all steps may be needed or performed in the order indicated here.

At Step 100, Vehicle: Detect Auto ignition attempt and send Vehicle id to Ground Station.

At Step 102, Ground station: Receive vehicle id, find in DMI database, check time zone, and time slots from database. If outside of time slot, send ignition close loop command to Vehicle to complete ignition.

At Step 104, Ground station: If within time slot, activate driver identification function. IVR: say your name.

At Step 106, Ground station: Receive and process voice sample name by comparing with DMI database.

At Step 108, Ground station: Name and profile found in database. IVR: initiate DMI Reaction time test. If not found send ignition close loop command to complete ignition.

At Step 110, Ground station: Conduct IVR based DMI Reaction Time test.

At Step 112, Vehicle: Relay Reaction Time test Voice commands from Ground station and driver voice response to Ground station.

At Step 114, Ground station: Compute and compare RT to driver specific and generic thresholds.

At Step 116, Ground station: Send ignition close loop command to vehicle if reaction time is within limits.

At Step 118, Vehicle: Receive Vehicle Ignition command and complete auto ignition.

As shown in FIG. 1A, the system 10 as described above is centralized in the ground station and is carried out via an IVR, a computer system, and database using software functions. Thus no hardware or software is installed in the vehicle other than the prior art satellite based auto safety system as described earlier. Such a system can be made specific to or programmed to the needs of a particular car and a particular driver and not all drivers of a car.

Alternatively, and as another embodiment, the safety function 42 can be built inside a computing device and installed in the vehicle itself. The technology of building such a device is prior art. Such an embodiment would not use or rely on the satellite based auto safety system. This embodiment may be useful for those vehicles that do not use or want to use a satellite-based auto safety system. In this embodiment, all the design details would remain the same as in the preferred embodiment described above, except the device is interfaced with the ignition of the car and the IVR needs to be interfaced with either the existing speaker and microphone inside the car or newly installed ones as part of this embodiment installation.

In summary, the DMI System 10 invention provides a mechanism by which a mentally impaired driver is stopped from starting a car when mentally impaired as determined by reaction time tests administered by an IVR system at the time of attempted auto ignition. The system excludes other drivers from such a test and includes only those drivers who have a drinking problem and also the system is run only on days and times when drinking is a problem, such as in evenings. For example it may not run in the morning when a person is going to work.

While the particular system and method as illustrated herein and disclosed in detail is fully capable of obtaining the objective and providing the advantages herein before stated, it is to be understood that it is merely illustrative of the presently preferred embodiments of the invention and that no limitations are intended to the details of construction or design herein shown other than as described in the appended claims.

What is claimed is:

1. A temporary mental impairment determination system comprising:
a. a device generating an aural stimulus in the form of a question to be heard by a subject;
b. the device having means to receive aural response to the stimulus from the subject;
c. a measurement means to measure aural response to determine mental impairment of the subject for the ability to safely operate machinery.

2. The claim as in 1, further comprising:
the measurement means include a plurality from the group of, the timeliness of the response relative to the stimulus and accuracy of the response relative to the stimulus.

3. The claim as in 2, further comprising:
a system for temporarily preventing drivers, mentally impaired from drugs and alcohol ingested impairment, from driving a vehicle having a mental impairment safety system that administers a reaction time test on attempted vehicle ignition and measures reaction time of driver by comparing responses to voice delivered questions.

4. The claim as in 3, further comprising:
comparing the measured reaction times to prior stored thresholds and
determining to complete ignition based on the results of the comparison.

5. A system for temporarily preventing drivers, mentally impaired from drugs and alcohol ingested impairment, from driving a vehicle comprising:
a. a prior art auto safety system using satellite control that remotely controls via a ground station a vehicle's operation to include vehicle ignition, and establishes voice communication with the driver;
b. a mental impairment safety function in the ground station that detects mental impairment of a driver and disables vehicle ignition if the driver is mentally impaired.

6. The system as in claim 5, comprising:
a. the vehicle adapted such that on attempted ignition of the vehicle, the prior art system communicates vehicle identification to the ground station;
b. the vehicle identification compared with a database to make a determination to initiate the mental impairment safety function, wherein the database has a vehicle profile that defines the specific vehicle and specific time windows when the test would be administered.

7. The system as in claim 5, the mental impairment safety function comprising:
a reaction time test that can be administered by voice interface between the driver and the ground station, which test leads to a determination of the degree of mental impairment that would affect safe operation of the vehicle.

8. The system as in claim 7, the reaction time test comprising:
a plurality of segments from a group of, (i) simple arithmetic questions, (ii) repetition of a sentence, (iii) answers to common questions, wherein delay in responses to questions from the group determine a reaction time at the instance of the driver attempting ignition of the vehicle.

9. The system as in claim 8, the reaction time test further comprising:
a driver profile that identifies a driver by voice sample and defines the reaction time profile thresholds of the driver.

10. The system as in claim 9, comprising:
a. a pre-stored data for each segment of test, driver profile contains generic reaction time thresholds and thresholds specific to a driver;
b. a function that inputs the measures of the reaction time of a driver to the plurality of reaction time test segments and compares with driver profile thresholds to determine to enable/disable ignition response.

11. The system as in claim 5, the system further comprising: comparing the driver voice sample to prior stored voice samples identifies the driver to be subjected to the safety function test.

12. A method for temporarily preventing drivers, mentally impaired from drugs and alcohol ingested impairment, from driving a vehicle comprising the steps of:
a. administering a reaction time test on attempted vehicle ignition on a vehicle equipped with a mental impairment safety system;
b. measuring the reaction time of driver by comparing responses to voice delivered questions.

13. The method as in claim 12, further comprising the steps of:
a. comparing the measured reaction times to prior stored thresholds;
b. determining to complete ignition based on the results of the comparison.

14. The method as in claim 13, further comprising the steps of:
dialing out a message of driver impairment with driver name, vehicle identification and location to a pre-designated person.

15. The method as in claim 12, further comprising the steps of:
administering reaction time test on certain time windows and certain days based on a specific driver drinking profile in a database.
